(19) United States
(12) Patent Application Publication
(10) Pub. No.: US 2019/0113627 A1
(43) Pub. Date: Apr. 18, 2019

(54) ENHANCED VEHICLE TRACKER

(71) Applicant: RAYTHEON BLACKBIRD TECHNOLOGIES, INC., Waltham, MA (US)

(72) Inventors: Michael D. Koontz, Chantilly, VA (US); Steven Talbot Hildner, Leesburg, VA (US); Andrew Hoai Tran, Herndon, VA (US); Meera Krishnan, Centreville, VA (US); Eric Arthur Banwart, Apex, NC (US); Kevin Craig Holley, Reston, VA (US); Torsten Albert Staab, Bristow, VA (US)

(21) Appl. No.: 16/162,177

(22) Filed: Oct. 16, 2018

Related U.S. Application Data
(60) Provisional application No. 62/573,342, filed on Oct. 17, 2017.

(51) Int. Cl. G01S 19/26; G08G 1/00; G01S 19/25; G01S 19/46; G01S 19/47; G01C 21/16

(52) U.S. Cl. CPC G01S 19/26; G08G 1/20; G01C 21/165; G01S 19/46; G01S 19/47; G01S 19/252

(57) ABSTRACT

An on-board system for location estimation and communication for a vehicle. In some embodiments, the on-board system includes a global navigation satellite system receiver, an inertial sensing system, a wireless receiver, and a processing circuit. The wireless receiver includes at least one of a cellular communications receiver, and a wireless local area networking receiver. The processing circuit is configured: to determine whether a global navigation satellite system signal is present, and in response to determining that a global navigation satellite system signal is present, to store, in the processing circuit: a current location estimate generated by the global navigation satellite system receiver, and a characterization of a radio-frequency environment measured by the wireless receiver; and in response to determining that a global navigation satellite system signal is not present, to estimate a location of the vehicle based on a characterization of a radio-frequency environment measured by the wireless receiver.

### CROSS-REFERENCE TO RELATED APPLICATION(S)

The present application claims priority to and the benefit of U.S. Provisional Application No. 62/573,342, filed Oct. 17, 2017, entitled “ENHANCED VEHICLE TRACKER”, the entire content of which is incorporated herein by reference.

### GOVERNMENT LICENSE RIGHTS

This invention was made with U.S. Government support under contract No. N41756-16-C-4521 awarded by the Department of Defense. The U.S. Government has certain rights in this invention.

### FIELD

One or more aspects of embodiments according to the present invention relate to tracking, and more particularly to an on-board system for a vehicle, for performing location estimation and communication.

### BACKGROUND

The ability to track the locations of vehicles has various commercial and military applications. Commercial applications include, for example, tracking fleets of delivery vehicles. A system relying on satellite-based location estimation, such as a Global Position System (GPS) receiver, may be unreliable when line-of sight reception from satellites is lost, as may occur, for example, in underground or covered parking areas.

Thus, there is a need for an improved on-board system for a vehicle, for performing location estimation and communication.

### SUMMARY

According to one embodiment, there is provided an on-board system for location estimation and communication for a vehicle, the on-board system including: a global navigation satellite system receiver; a wireless receiver; and a first processing circuit, the wireless receiver including at least one of: a cellular communications receiver, and a radio wireless local area networking receiver, the first processing circuit being configured to: determine whether a global navigation satellite system signal is present; in response to determining that a global navigation satellite system signal is present, to store, in the first processing circuit: a current location estimate generated by the global navigation satellite system receiver, and a characterization of a radio-frequency environment measured by the wireless receiver; and in response to determining that a global navigation satellite system signal is not present, to estimate a location of the vehicle based on a characterization of a radio-frequency environment measured by the wireless receiver.

In some embodiments, the wireless receiver includes a cellular communications receiver, and the cellular communications receiver is a Global System for Mobile communications receiver.

In some embodiments, the on-board system further includes an on-board diagnostics connection to the vehicle, the first processing circuit being further configured, in response to determining that a global navigation satellite system signal is not present, to fetch a wheel revolution counter value through the on-board diagnostics connection, and to estimate, from the wheel revolution counter value, a distance traveled from a previously known vehicle location.

In some embodiments, the on-board system further includes an inertial sensing system, and the first processing circuit is further configured, in response to determining that a global navigation satellite system signal is not present, to read a plurality of angular rates and a plurality of rates of acceleration from the inertial sensing system, and to estimate, from the angular rates and the rates of acceleration, a change in the location of the vehicle.

In some embodiments, the on-board system further includes a microphone, and the first processing circuit is further configured, in response to determining that a global navigation satellite system signal is not present, to sense an acoustic environment of the vehicle, and to infer a location of the vehicle based on the acoustic environment of the vehicle.

In some embodiments, the on-board system further includes a camera, and the first processing circuit is further configured, in response to determining that a global navigation satellite system signal is not present, to sense a visual environment of the vehicle, and to infer a location of the vehicle based on the visual environment of the vehicle.

In some embodiments, the on-board system further includes a cellular data transmitter, and the first processing circuit is further configured to periodically transmit an estimated location of the vehicle to a home server through the cellular data transmitter.

In some embodiments, the on-board system further includes a satellite data transmitter, and the first processing circuit is further configured to periodically transmit an estimated location of the vehicle to a home server through the satellite data transmitter.

In some embodiments, the on-board system further includes a second processing circuit, and the second processing circuit is configured to: determine whether the vehicle has been in a low-power mode for an interval of time exceeding a first threshold, and based on determining that the vehicle has been in a low-power mode for an interval of time exceeding the first threshold, disable the first processing circuit.

In some embodiments, the global navigation satellite system receiver is connected to the first processing circuit through the second processing circuit.

According to one embodiment, there is provided a method for location estimation and communication using an on-board system on a vehicle, the on-board system including: a global navigation satellite system receiver; a wireless receiver; and a first processing circuit, the wireless receiver including at least one of: a cellular communications receiver, and a radio wireless local area networking receiver, the method including: determining whether a global navigation satellite system signal is present; in response to determining that a global navigation satellite system signal is present, storing, in the first processing circuit: a current location estimate generated by the global navigation satellite system receiver, and a characterization of a radio-frequency environment measured by the wireless receiver; and in response to determining that a global navigation satellite system signal is not present, estimating a location of the vehicle based on a characterization of a radio-frequency environment measured by the wireless receiver.

In some embodiments, the wireless receiver includes a cellular communications receiver, and the cellular communications receiver is a Global System for Mobile communications receiver.

In some embodiments, the on-board system further includes an on-board diagnostics connection to the vehicle, the method further including, in response to determining that a global navigation satellite system signal is not present, fetching a wheel revolution counter value through the on-board diagnostics connection, and estimating, from the wheel revolution counter value, a distance traveled from a previously known vehicle location.

In some embodiments, the on-board system further includes an inertial sensing system, the method further including: in response to determining that a global navigation satellite system signal is not present, reading a plurality of angular rates and a plurality of rates of acceleration from the inertial sensing system, and estimating, from the angular rates and the rates of acceleration, a change in the location of the vehicle.

In some embodiments, the on-board system further includes a microphone, and the method further includes: in response to determining that a global navigation satellite system signal is not present, sensing an acoustic environment of the vehicle, and inferring a location of the vehicle based on the acoustic environment of the vehicle.

In some embodiments, the on-board system further includes a camera, and the method further includes: in response to determining that a global navigation satellite system signal is not present, sensing a visual environment of the vehicle, and inferring a location of the vehicle based on the visual environment of the vehicle.

In some embodiments, the on-board system further includes a cellular data transmitter, and the method further includes periodically transmitting an estimated location of the vehicle to a home server through the cellular data transmitter.

In some embodiments, the on-board system further includes a satellite data transmitter, and the method further includes periodically transmitting an estimated location of the vehicle to a home server through the satellite data transmitter.

In some embodiments, the on-board system further includes a second processing circuit, and the method further includes:

determining, by the second processing circuit, whether the vehicle has been in a low-power mode for an interval of time exceeding a first threshold, and based on determining that the vehicle has been in a low-power mode for an interval of time exceeding the first threshold, disabling, by the second processing circuit, the first processing circuit.

In some embodiments, the global navigation satellite system receiver is connected to the first processing circuit through the second processing circuit.

### BRIEF DESCRIPTION OF THE DRAWINGS

Features, aspects, and embodiments are described in conjunction with the attached drawings, in which:

FIG. 1 is a block diagram of an enhanced vehicle tracker and a home server, according to an embodiment of the present invention; and

FIG. 2 is a flow chart of a portion of a method of operation of an enhanced vehicle tracker, according to an embodiment of the present invention.

### DETAILED DESCRIPTION

The detailed description set forth below in connection with the appended drawings is intended as a description of exemplary embodiments of an enhanced vehicle tracker provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the scope of the invention. As denoted elsewhere herein, like element numbers are intended to indicate like elements or features.

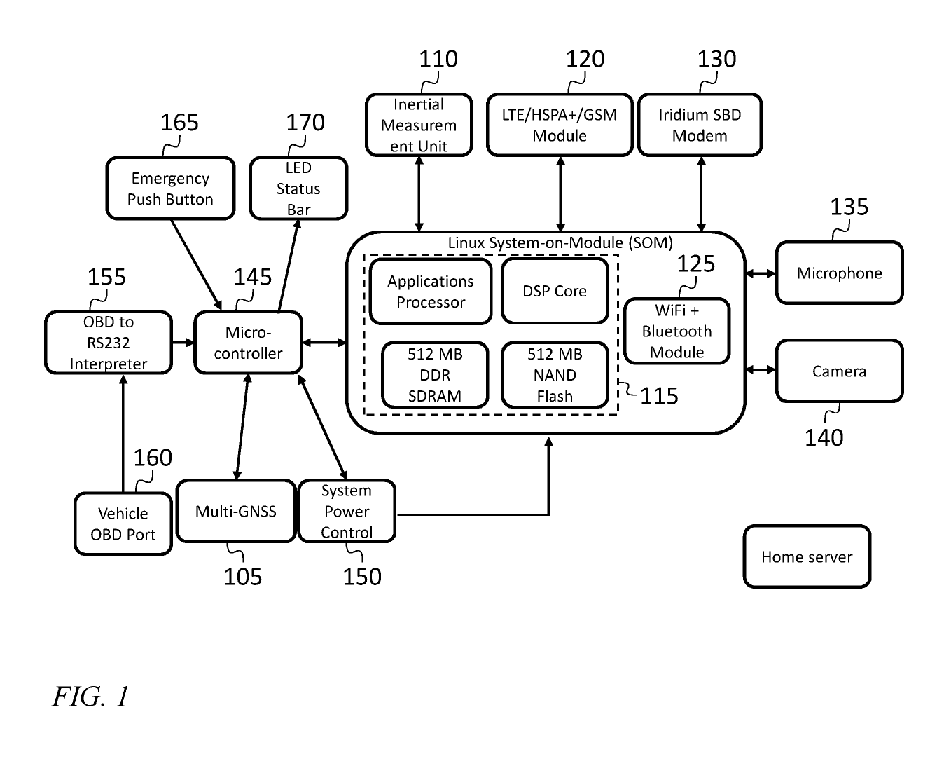

Referring to FIG. 1, in some embodiments, an enhanced vehicle tracker is an on-board system in a vehicle, that includes a global navigation satellite system (GNSS) receiver 105, an inertial sensing system 110 (or “inertial measurement unit (IMU)” or “inertial navigation system (INS)”), a wireless receiver, and a first processing circuit 115. The wireless receiver may include at least one of a cellular communications receiver (e.g., a Global System for Mobile communications (GSM) receiver) and a wireless local area networking receiver; the former may be part of a cellular communications transceiver 120, and the latter may be a WiFi receiver that is part of a WiFi (transceiver) and Bluetooth module 125 as shown. In another embodiment, the wireless receiver is (or includes) a software-defined radio. In this embodiment, the wireless receiver may include a cellular communications receiver and/or a wireless local area networking receiver by being configured (or configurable) to operate as a cellular communications receiver or as a wireless local area networking receiver, or both. The first processing circuit may be part of Linux System-on-module (SOM) that includes an ARM Cortex-A8 processor as an applications processor.

The global navigation satellite system receiver 105 may be a standalone module as illustrated in FIG. 1, or it may be part of a module also including an inertial sensing system which may supplement the inertial sensing system 110 illustrated in FIG. 1 or which may be present instead of the inertial sensing system 110 illustrated in FIG. 1. Such a module may include several different types of global navigation satellite system receivers (including, e.g., a GPS receiver) and may be used for both satellite navigation and for dead reckoning (using the inertial sensing system), and may therefore be referred to as a “Multi-GNSS+dead reckoning module”.

The enhanced vehicle tracker may further include a satellite communications modem 130 (including a satellite data transmitter and a satellite data receiver), a microphone 135, and a camera 140. A second processing circuit 145 may be connected to the first processing circuit 115 as shown. The second processing circuit 145 (which may be an ARM Cortex M0+microcontroller) may also be connected to the global navigation satellite system receiver 105 (which, in some embodiments, may instead be directly connected to the first processing circuit 115), a system power control circuit 150, an on-board diagnostics (OBD) (e.g., OBD-II) to RS-232 interpreter 155 (which may be connected to an OBD-II port 160 of the vehicle), an emergency push button 165, and an LED status bar 170. The microphone 135 need not be wired in to the on-board system. For example, the microphone 135 may be a component of a smart phone, and connected, through a Bluetooth connection, to at least one of the first processing circuit 115 and the second processing circuit 145. Similarly, the camera 140 need not be wired in to the on-board system. For example, the camera 140 (which may be capable of acquiring still images and/or video) may be a component of a smart phone, and connected, through a Bluetooth connection or through a WiFi connection, to at least one of the first processing circuit 115 and the second processing circuit 145.

In operation, the enhanced vehicle tracker may provide multiple functions, including estimating the location of the vehicle using various different methods, reporting the estimated location of the vehicle to a home server 180, reporting emergencies to the home server, reporting sensor data to the home server (for storage in a home server database and for use in future location estimation operations, as described in further detail below) and fetching data (e.g., data stored in the home server database) from the home server. The home server may be at a fixed location, with a connection to (i) the cellular data network, and (ii) the satellite communication system with which the enhanced vehicle tracker is configured to communicate, through the satellite communications modem 130.

For example, in operation, the first processing circuit 115 may determine, e.g., from data it receives from the global navigation satellite system receiver 105, whether a global navigation satellite system signal is present. When a global navigation satellite system signal (e.g., a GPS signal) is present, the global navigation satellite system receiver 105 may generate a stream of relatively high quality vehicle location estimates. The enhanced vehicle tracker may relay these estimates of the location of the vehicle to the home server (through any of the communications channels it may have to the home server, e.g., over the cellular network or over the satellite communication system), which may use them for routine tracking operations, e.g., reassigning tasks (such as delivery tasks, or service tasks) originally assigned to a first vehicle of a fleet to a second vehicle of the fleet, when the first vehicle falls behind schedule. The enhanced vehicle tracker may also relay, to the home server, data acquired by any or all of its sensors, e.g., by the cellular communications receiver, the wireless local area networking receiver, the microphone, or the camera, for storage in the home server database, along with the location at which the data were acquired. As used herein, “a global navigation satellite system signal is present” means that the enhanced vehicle tracker is receiving signals of sufficient strength from a sufficient number of global navigation satellite system satellites to form a meaningful location estimate (i.e., to have a “global navigation satellite system fix” or a “GPS fix”).

When the first processing circuit 115 determines that a global navigation satellite system signal is not present (i.e., when no global navigation satellite system signal is present), the enhanced vehicle tracker may fall back to one or more alternate methods of estimating the location of the vehicle. These may include estimating the location of the vehicle using dead reckoning, or using the sensed environment of the enhanced vehicle tracker. The environment of the enhanced vehicle tracker may include the radio frequency environment of the enhanced vehicle tracker (as sensed by the wireless local area networking receiver or by the cellular communications receiver, or both), the acoustic environment of the enhanced vehicle tracker (as sensed by the microphone), and the visual environment of the enhanced vehicle tracker (as sensed by the camera).

When the location of the vehicle is estimated using the environment of the enhanced vehicle tracker, the home server may, if a communication link between the enhanced vehicle tracker and the home server is available, participate in the estimation process, for example, by furnishing data from the home server database that may be used to infer the location of the vehicle, from a presently existing environment. In other embodiments, the enhanced vehicle tracker may include a local database and it may be capable of estimating the location of the vehicle even when no communication link between the enhanced vehicle tracker and the home server is available. When a communication link between the enhanced vehicle tracker and the home server is available, the tasks of estimating the location of the vehicle and of furnishing data for the estimating of the location of the vehicle may each be performed either by the home server or by the enhanced vehicle tracker. In some embodiments, the home server database includes data provided by each of the vehicles of a fleet of vehicles and may therefore be significantly more comprehensive than the data that may be provided by any one of the vehicles of the fleet.

The estimating of the location of the vehicle using dead reckoning may be performed by estimating a change in the location of the vehicle and adding this change to a previously known vehicle location. The previously known vehicle location may be the estimated location of the vehicle as provided by the global navigation satellite system receiver 105 when a global navigation satellite system signal was last present, or it may be a previously estimated location produced by dead reckoning or using the sensed environment of the enhanced vehicle tracker. The change in the location of the vehicle may be estimated by accumulating, or “integrating”, the accelerations and angular rates sensed by the inertial sensing system 110 (or by one or more of the inertial sensing systems, if several inertial sensing systems are present in the enhanced vehicle tracker), or by integrating the rotation of the vehicle's wheels, using the steering angle of the vehicle. The rotation of the vehicle's wheels may be sensed by sensors (e.g., Hall effect sensors) installed near the paths of magnets attached to the wheels, and the steering angle of the vehicle may be sensed by a suitable encoder secured to the steering gear. Both wheel rotations (or “wheel ticks”) and steering angle may be read from the vehicle through the vehicle's OBD (e.g., OBD-II) port 160. The accuracy of estimates generated using dead reckoning may degrade over time, and, as such, estimates generated using dead reckoning may be most accurate immediately after the global navigation satellite system signal is lost.

The estimating of the location of the vehicle using the acoustic environment of the enhanced vehicle tracker may be performed by comparing the present acoustic environment of the enhanced vehicle tracker to a library of geo-coded acoustic environments stored in the home server database or in the local database. The library may be one that was created from acoustic environments that the vehicle (or other vehicles in a fleet of vehicles) sensed and reported, or it may have been created by other methods, e.g., from public information about locations of acoustic sources (such as airports or airplanes, church bells, or a subway) and generic models of such sources. A machine learning system, e.g., a neural network, may be trained to recognize different acoustic environments and to return the location of an acoustic environment that best matches the present acoustic environment of the enhanced vehicle tracker. Such a neural network may be implemented using a Deep Learning-based neural network. In some embodiments, digital hashes of regional, geo-coded, acoustic signatures are stored in flash memory in the enhanced vehicle tracker to allow for local processing and decision making in situations when a connection to the home server is not available.

The estimating of the location of the vehicle using the visual environment of the enhanced vehicle tracker may be performed by comparing the present visual environment of the enhanced vehicle tracker to a library of geo-coded visual environments stored in the home server database or in the local database. For example, in an urban environment, machine vision (using a wirelessly-connected, on-board, or wired-in camera; and using processing performed in the enhanced vehicle tracker or in the home server, or both) may recognize street signs, or signs on businesses, or the like, and a suitable algorithm may then be used to infer the location of the vehicle, or that the vehicle is at one of several candidate locations. For example, if two street signs identifying an intersection are visible and recognized, the vehicles location may be determined to be at that intersection. If instead the name of a store or restaurant that is a member of a chain of such stores or restaurants is recognized, then it may be inferred that the vehicle is in front of one such business that is within a largest region plausibly including the current location of the vehicle. In other embodiments, the system may recognize landmarks, such as a building having a distinctive shape, or a distinctive geographic feature.

Such an observation may be useful for dramatically improving the precision of the estimate of the location of the vehicle. For example, if, because of the limited accuracy of dead reckoning, the location of the vehicle is only known to an accuracy of 1000 yards, then recognizing a business of which there is only one within 1000 yards of the estimated location of the vehicle may be sufficient to determine the location of the vehicle to within a few yards. This image-based scene analysis and geo-inferencing can be implemented using various machine learning-based approaches, such as Deep Learning or Wavelet analysis. In some embodiments, digital hashes of regional, geo-coded, images are stored in flash memory in the enhanced vehicle tracker, to allow for local processing and decision making in situations when a connection to the home server is not available.

The radio frequency environment of the vehicle may similarly be used to estimate the location of the vehicle. For example, the wireless receiver may periodically transmit, to the first processing circuit 115, a characterization of the current radio frequency environment. This characterization may consist, for example, of the frequency (e.g., in MHz) and current received signal strength (e.g., in dBm) of each of a plurality of received signals from a corresponding plurality of radio frequency sources. Such sources may include cellular communications towers and radio wireless local area networking (e.g., WiFi) hotspots, for example. The enhanced vehicle tracker (or the home server) may then compare the current radio frequency environment to a map of radio frequency environments, to identify a location that best matches the current radio frequency environment. This location may then be used as the estimated location of the vehicle.

The map may be generated by various methods. For example, a physical model-based method may be used. The location of cellular communications towers and the transmitted power at each of the transmitted frequencies may be known from public records. Each cellular communications towers may then be modeled as an isotropic radiator, and the received power calculated as a function of distance from the tower using the inverse square law. If the enhanced vehicle tracker is within range of three cellular communications towers then this method may be used to infer the distance from the enhanced vehicle tracker to each of the three towers, and trilateration may then be used to determine the location of the vehicle.

Such an approach may be imperfect because, for example, cellular communications towers may not radiate isotropically, and because reflections (e.g., from buildings) or attenuation (e.g., by buildings) may affect the radio frequency environment at the enhanced vehicle tracker. More empirical approaches may therefore be taken. For example, the radiation pattern of each tower may be modeled by a parametric model (with, for example the azimuthal variation being modeled by a first spline (e.g., a first piecewise cubic spline) and the variation as a function of elevation being modeled by a second spline (e.g., a second piecewise cubic spline). The parameters may be estimated from driving past the cellular communications tower and sensing the radio frequency power received along the route traveled.

In another empirical approach the radio frequency environment is characterized over a set of locations by the vehicle (or by each of the vehicles in a fleet) as it travels (or as they travel) and a surface is fit to the measured received power at each frequency received (e.g., using a two-dimensional spline). To estimate the location of the enhanced vehicle tracker, the location at which the measured received power best matches the received power predicted by the surface at each measured frequency is used.

Hybrid methods combining these two approaches may also be used. For example, the physical model-based method may be used to generate a coarse estimate of the location of the vehicle, and a two-dimensional spline fit to local characterizations of the radio frequency environment may be used to generate a more accurate estimate of the location of the vehicle.

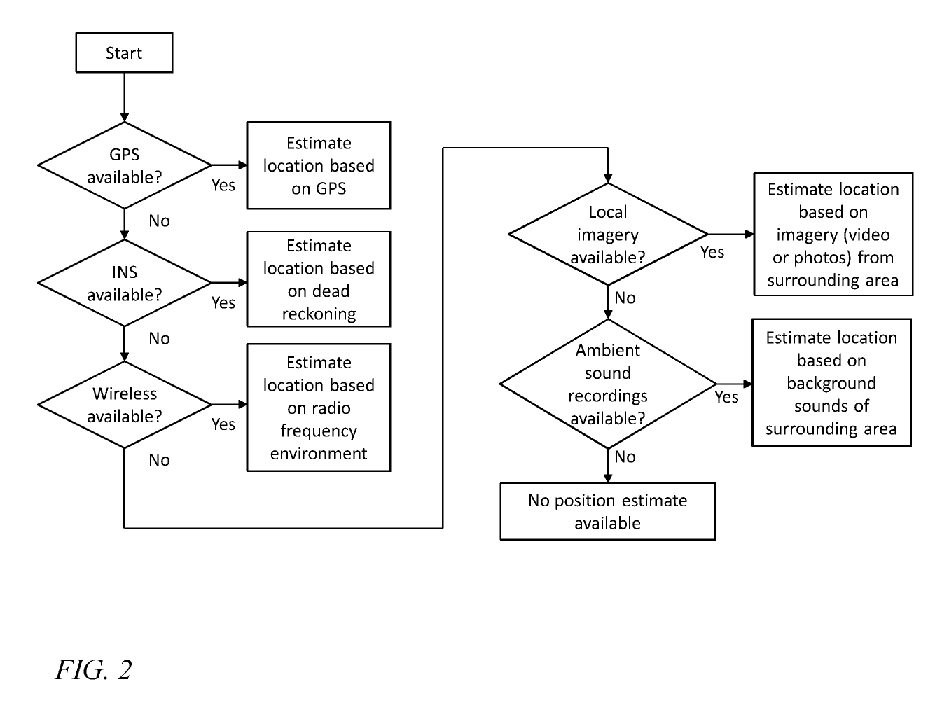

In some embodiments a “layered” approach is used to estimate the location of the vehicle. For example, referring to FIG. 2, a first layer may correspond to GPS sensing; if GPS sensing is available, it is used to estimate the location of the vehicle. The second layer may correspond to dead reckoning using the inertial sensing system 110; if GPS sensing is not available and inertial sensing (INS) is available (e.g., it has not been unacceptably degraded by the passage of time), inertial sensing is used to estimate the location of the vehicle. The third layer may correspond to location estimation using the radio frequency environment; if GPS sensing is not available and inertial sensing (INS) is not available (e.g., if the accuracy of dead reckoning has degraded, as it may over time, to the point of making location estimates based on dead reckoning essentially useless), and if wireless signals are available, the radio frequency environment is used to estimate the location of the vehicle. The fourth layer provides means for location inferencing from camera-collected photos or video footage of the surrounding area. The fifth layer uses microphone-collected acoustic data to match ambient background sound recordings to geo-coded acoustic signatures (e.g., regional airports, train stations, etc.) of known locations.

In some embodiments, an emergency button 165 may be available for an operator of the vehicle to push, to notify the home server of an emergency (e.g., a breakdown of the vehicle, or a carjacking or the like). The enhanced vehicle tracker may send a suitable notification to the home server when the emergency button 165 is pushed.

In some embodiments, the second processing circuit 145 may have control over the system power control circuit 150, and may be able to disable the first processing circuit 115 (e.g., put it in a sleep or hibernation mode, or shut it down entirely) and to disable peripheral components connected to it, such as the inertial sensing system 110 or the cellular communications transceiver 120 shown connected to the first processing circuit 115 in FIG. 1. This ability may be used to conserve energy when appropriate. For example, if the vehicle is in a low-power mode (e.g., if its engine is shut off) for more than a threshold interval of time (e.g., for more than 30 minutes) the second processing circuit 145 may disable the first processing circuit 115 and the peripherals connected to it, to reduce power consumption, until the vehicle transitions out of the low-power mode (e.g., until the vehicle's engine is started).

In some embodiments, the enhanced vehicle tracker shares location estimation with other vehicles of a fleet. A fleet of vehicles also may implement collaborative location sharing and inferencing among multiple enhanced vehicle trackers. Such features may operate either through a connection with the home server or “peer-to-peer” communications among multiple enhanced vehicle trackers (e.g., ad-hoc IP- or Wifi-based mesh networking). Fleet vehicles equipped with enhanced vehicle trackers may, in such embodiments, improve their location estimates by leveraging location information from nearby vehicles, as, for example, if three vehicles are driving in a linear convoy formation. In such a scenario, the lead vehicle and the last vehicle may still have a GPS fix and a good location, while the vehicle in the middle (the second vehicle) may have lost its GPS fix (e.g., because the GPS signal is being jammed or the vehicle is driving through an urban “canyon” that obstructs the GPS satellite link temporarily). The enhanced vehicle tracker of the second vehicle may then ping nearby enhanced vehicle trackers (in this example, the lead vehicle and the last vehicle e.g., via ad-hoc GSM IP-based or Wifi mesh networking; car-2-car communication protocols like Car-to-X may be used to similar effect) and may then use the location from the lead and last vehicle, last known inter-vehicle distances, each vehicles speed and direction of travel, RF signal strength indicator, etc., to improve its location estimate.

As used herein, when an action is taken or an estimate produced “based on” a certain input, it means that the taking of the action or the calculation of the estimate is influenced by one or more factors, including the input. It will be understood that features disclosed herein improve the technology of tracking and particularly of vehicle tracking, by improving reliability and robustness to loss of a default tracking method (e.g., loss of GPS signal).

The term “processing unit” is used herein to include any combination of hardware, firmware, and software, employed to process data or digital signals. Processing unit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing unit, as used herein, each function is performed either by hardware configured, i.e., hard-wired, to perform that function, or by more general purpose hardware, such as a CPU, configured to execute instructions stored in a non-transitory storage medium. A processing unit may be fabricated on a single printed circuit board (PCB) or distributed over several interconnected PCBs. A processing unit may contain other processing units; for example a processing unit may include two processing units, an FPGA and a CPU, interconnected on a PCB.

Although limited embodiments of an enhanced vehicle tracker have been specifically described and illustrated herein, many modifications and variations will be apparent to those skilled in the art. Accordingly, it is to be understood that an enhanced vehicle tracker employed according to principles of this invention may be embodied other than as specifically described herein. The invention is also defined in the following claims, and equivalents thereof.

What is claimed is:

1. An on-board system for location estimation and communication for a vehicle, the on-board system comprising:
a global navigation satellite system receiver;
a wireless receiver; and
a first processing circuit,
the wireless receiver comprising at least one of:
a cellular communications receiver, and
a radio wireless local area networking receiver,
the first processing circuit being configured to:
determine whether a global navigation satellite system signal is present;
in response to determining that a global navigation satellite system signal is present, to store, in the first processing circuit:
a current location estimate generated by the global navigation satellite system receiver, and
a characterization of a radio-frequency environment measured by the wireless receiver; and
in response to determining that a global navigation satellite system signal is not present, to estimate a location of the vehicle based on a characterization of a radio-frequency environment measured by the wireless receiver.

2. The on-board system of claim 1, wherein the wireless receiver comprises a cellular communications receiver, and the cellular communications receiver is a Global System for Mobile communications receiver.

3. The on-board system of claim 1, further comprising an on-board diagnostics connection to the vehicle, the first processing circuit being further configured, in response to determining that a global navigation satellite system signal is not present,
to fetch a wheel revolution counter value through the on-board diagnostics connection, and
to estimate, from the wheel revolution counter value, a distance traveled from a previously known vehicle location.

4. The on-board system of claim 1, further comprising an inertial sensing system, wherein the first processing circuit is further configured, in response to determining that a global navigation satellite system signal is not present,
to read a plurality of angular rates and a plurality of rates of acceleration from the inertial sensing system, and
to estimate, from the angular rates and the rates of acceleration, a change in the location of the vehicle.

5. The on-board system of claim 1, further comprising a microphone,
wherein the first processing circuit is further configured, in response to determining that a global navigation satellite system signal is not present,
to sense an acoustic environment of the vehicle, and
to infer a location of the vehicle based on the acoustic environment of the vehicle.

6. The on-board system of claim 1, further comprising a camera,
wherein the first processing circuit is further configured, in response to determining that a global navigation satellite system signal is not present,
to sense a visual environment of the vehicle, and
to infer a location of the vehicle based on the visual environment of the vehicle.

7. The on-board system of claim 1, further comprising a cellular data transmitter, wherein the first processing circuit is further configured to periodically transmit an estimated location of the vehicle to a home server through the cellular data transmitter.

8. The on-board system of claim 1, further comprising a satellite data transmitter, wherein the first processing circuit is further configured to periodically transmit an estimated location of the vehicle to a home server through the satellite data transmitter.

9. The on-board system of claim 1, further comprising a second processing circuit, wherein the second processing circuit is configured to:
determine whether the vehicle has been in a low-power mode for an interval of time exceeding a first threshold, and
based on determining that the vehicle has been in a low-power mode for an interval of time exceeding the first threshold, disable the first processing circuit.

10. The on-board system of claim 9, wherein the global navigation satellite system receiver is connected to the first processing circuit through the second processing circuit.

11. A method for location estimation and communication using an on-board system on a vehicle, the on-board system comprising:
a global navigation satellite system receiver;
a wireless receiver; and
a first processing circuit,
the wireless receiver comprising at least one of:
a cellular communications receiver, and
a radio wireless local area networking receiver,
the method comprising:
determining whether a global navigation satellite system signal is present;
in response to determining that a global navigation satellite system signal is present, storing, in the first processing circuit:
a current location estimate generated by the global navigation satellite system receiver, and
a characterization of a radio-frequency environment measured by the wireless receiver; and
in response to determining that a global navigation satellite system signal is not present, estimating a location of the vehicle based on a characterization of a radio-frequency environment measured by the wireless receiver.

12. The method of claim 11, wherein the wireless receiver comprises a cellular communications receiver, and the cellular communications receiver is a Global System for Mobile communications receiver.

13. The method of claim 11, wherein the on-board system further comprises an on-board diagnostics connection to the vehicle, the method further comprising, in response to determining that a global navigation satellite system signal is not present,
fetching a wheel revolution counter value through the on-board diagnostics connection, and
estimating, from the wheel revolution counter value, a distance traveled from a previously known vehicle location.

14. The method of claim 11, wherein the on-board system further comprises an inertial sensing system, the method further comprising:
in response to determining that a global navigation satellite system signal is not present,
reading a plurality of angular rates and a plurality of rates of acceleration from the inertial sensing system, and
estimating, from the angular rates and the rates of acceleration, a change in the location of the vehicle.

15. The method of claim 11, wherein the on-board system further comprises a microphone, and wherein the method further comprises:
in response to determining that a global navigation satellite system signal is not present,
sensing an acoustic environment of the vehicle, and
inferring a location of the vehicle based on the acoustic environment of the vehicle.

16. The method of claim 11, wherein the on-board system further comprises a camera, and wherein the method further comprises:
in response to determining that a global navigation satellite system signal is not present,
sensing a visual environment of the vehicle, and
inferring a location of the vehicle based on the visual environment of the vehicle.

17. The method of claim 11, wherein the on-board system further comprises a cellular data transmitter, and wherein the method further comprises periodically transmitting an estimated location of the vehicle to a home server through the cellular data transmitter.

18. The method of claim 11, wherein the on-board system further comprises a satellite data transmitter, and wherein the method further comprises periodically transmitting an estimated location of the vehicle to a home server through the satellite data transmitter.

19. The method of claim 11, wherein the on-board system further comprises a second processing circuit, and wherein the method further comprises:
determining, by the second processing circuit, whether the vehicle has been in a low-power mode for an interval of time exceeding a first threshold, and
based on determining that the vehicle has been in a low-power mode for an interval of time exceeding the first threshold, disabling, by the second processing circuit, the first processing circuit.

20. The method of claim 19, wherein the global navigation satellite system receiver is connected to the first processing circuit through the second processing circuit.
